(19) United States
(12) Patent Application Publication
(10) Pub. No.: US 2008/0215737 A1
(43) Pub. Date: Sep. 4, 2008

(54) Method for Controlling Communication in a Decentralized Network

(75) Inventor: Walter Klausberger, Wolfpassing (AT)

Correspondence Address: BELL, BOYD & LLOYD, LLP, P.O. BOX 1135, CHICAGO, IL, 60690, US

(73) Assignee: Nokia Siemens Networks GmbH & Co. KG

(21) Appl. No.: 11/996,700

(22) PCT Filed: Jul. 19, 2006
(86) PCT No.: PCT/EP06/64411

§ 371 Date: Mar. 17, 2008

(30) Foreign Application Priority Data
Jul. 25, 2005 (DE) 10 2005 034 693.6

(51) Int. Cl. G06F 15/173

(52) U.S. Cl. 709/226

(57) ABSTRACT

The invention describes a method for controlling communication in a decentralized network (P2P), in which reciprocal decentralized communication is provided for a multiplicity of network elements (C1, C2, C3, C4, CX). In this case, provision is made for at least one identity code which is unique in the decentralized network (P2P) to be assigned to a user of a first network element (C1), for at least one user group to be able to be assigned to the identity code, and for a profile for defining communication settings to be assigned to a user group.

### CLAIM FOR PRIORITY

This application is a national stage of PCT/EP2006/064411, which was filed Jul. 19, 2006, and which claims the benefit of priority to DE 10 2005 034 693.6, filed Jul. 25, 2005, the contents of which are hereby incorporate by reference.

### TECHNICAL FIELD OF THE INVENTION

The invention relates to a method for controlling communication in a decentralized network, particularly a peer-to-peer network.

### BACKGROUND OF THE INVENTION

In the prior art, decentralized networks are known in which a predominant proportion of connected network elements offer functions and services to other network elements and, on the other hand, use functions and services offered by other network elements without a central controlling entity for controlling the communication session having to be provided for this purpose. In this context, a network element participating in this decentralized network assumes a role as server or as client, respectively, with respect to another network element. As delimitation from a usual client-server architecture, such a network element is frequently also called “peer”. Accordingly, decentralized networks of this type are also designated as “peer-to-peer networks” or abbreviated as P2P networks.

Incidentally, a delimitation of the terms of this decentralized network does not generally exclude the presence of central entities such as, for example, servers. Mixed forms of networks in which certain tasks are shifted to a central entity, or to a server, respectively, are also referred to with the designation decentralized network or P2P network as long as these networks do not contain a server via which any communication session between two network elements has to be conducted.

On the network elements, an application is usually executed which provides for a search for decentralized network partners and a decentralized communication with these. In this context, this application and an associated decentralized network cannot be unambiguously separated from one another since a decentralized network is usually formed by a multiplicity of users of this application, which is why this is also frequently called a “community”.

Usually, an identity of the user in the form of an identity code which identifies the user of the application must be defined in such an application before a decentralized communication is started in the decentralized network.

In data networks, the term “identity code” refers to a code conveyed in the form of a network address or of a network name in a data communication. In decentralized networks, this form of an identity is usually hidden from other network elements. Instead, a user name has gained acceptance as identity code in decentralized networks—and incidentally also in some centralized networks. The user name is here freely selectable by the user unless it corresponds to or collides with a user name already issued in the decentralized network. Frequently, a nickname is selected as identity code.

The identity code is defined for a respective application. In a decentralized network, an identity code is thus normally unique with respect to other network elements which use the same application for decentralized communication.

After a choice of an identity code, a user of the application is fixed to a “role” which, in most cases, only consists in the role of a “peer”, that is to say an equal distribution of rights of all users participating in the decentralized network. With an increase in complexity of the decentralized network—or also for other reasons such as administrability, safety requirements etc.—there is a need to define communication settings—such as, e.g. the role addressed as administrator, operator etc.—more precisely and to change or to adapt it, if necessary.

### SUMMARY OF THE INVENTION

The invention provide a device, computer program product and method for controlling communication in a decentralized network.

In one embodiment according to the invention, at least one identity code which is unique in the decentralized network is allocated to a user of a first network element—or more specially: to an application. According to the invention, this identity code can be allocated to a user group which contains a profile with different communication settings.

In another embodiment according to the invention, and based on the central concept of extending the traditional equal rights of all network elements or peers in a decentralized network or peer-to-peer network, respectively, by a structured definition of communication settings contained in a profile without deviating from the principle of architecture of equal rights of the network elements.

In this context, the use of allocatable user groups offers a particular advantage for a simple change of roles. For example, an operator “Max” can allocate himself to a user group “work” for professional purposes and to a user group “home” for private utilization. In this arrangement, communication settings are provided for the user group “work” in the associated profile which, for example, provide visibility only for the other members of this user group. A further communication setting can provide an encrypted communication or exclude the use of certain services such as, e.g. the “chat” services.

The use of allocatable user groups also has advantages for the unification of the control of communication. If hitherto a restriction of the manner of communication (e.g. visibility or a requirement of encrypted connection to certain peers) was only possible by installing and using a differently configured application instead of the application used hitherto, the means according to the invention provide for a uniform application for all participants which selects its manner of communication by allocation to a user group.

An allocation can advantageously also be made by an authorized user, e.g. administrator, since a role as “administrator” or “user” can also be provided in the communication settings.

### BRIEF DESCRIPTION OF THE DRAWINGS

In the text which follows, an exemplary embodiment with advantages and arrangement of the invention will be explained in greater detail with reference to the drawing.

FIG. 1 shows a structural pattern for the diagrammatic representation of a decentralized network.

### DETAILED DESCRIPTION OF THE INVENTION

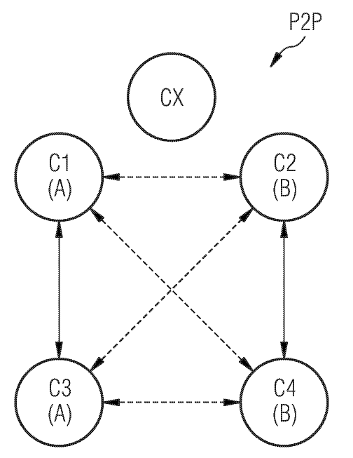

FIG. 1 shows a decentralized network P2P with a multiplicity of network elements C1, C2, C3, C4, CX. In each network element, a number of user groups, not shown, are defined which are also available in all other network elements. User groups to which a user can allocate himself with his identity code are therefore preferably defined decentralized and known in the entire decentralized network P2P.

Optionally or additionally, such user groups are also present in a network element CX which is distinguished by a role as administrator. This role as administrator was allocated to an operator of the network element CX or, respectively, to the peer-to-peer application running on the network element CX with which the operator has registered with his identity code, or to the network element CX, respectively, preferably by a communication setting in the profile of his associated user group.

In this connection, the term network element C1, C2, C3, C4, CX is understood to be, apart from a network participant, also an application with the use of which a participation, communication and setting up of service relations takes place.

The user groups present in the individual network elements C1, C2, C3, C4, CX contain a profile in which communication settings are present. These communication settings include, among other things, visibility rules, authentications, authorizations and encryption for connections.

When a user is set up in the decentralized network P2P, the user is assigned an identity code and a membership of a user group. This assignment can be made initially to a “default user group” with preallocated default settings. If a user, after registering by inputting his identity code, then registers in the decentralized network P2P via an application running on his network element, the communication settings corresponding to his profile automatically come into force.

The user can change his communication settings in a simple manner by changing the allocation of a user group to his identity code. For example, a user “Max” can change his user group “home” into a user group “work”. This change in the allocation makes it possible to handle a number of roles with different requirements by simple means on one and the same peer-to-peer platform. For the purpose of controlling communication, it can be provided within a user group that a user is only allocated by conveying a password and/or a key.

For setting up user groups, a specially equipped network element CX can be optionally or additionally provided which, for example, assumes a role as administration client. As an alternative or additionally, an administration mode is provided for network elements C1, C2, C3, C4 which, for example, is accessible by allocation to the user group “administrators” by depositing a password or a corresponding key, respectively.

When a user registers with his identity code, a user group last allocated to this identity code is sought in the decentralized network. The user or the application used by the user thereupon automatically receives the rights or communication settings allocated to the user group. As is normal in the decentralized networks, an allocation of the identity code to a user group is administered distributed in the decentralized network P2P. As an alternative or additionally, however, an administration on central or redundant servers can also be provided.

Referring to the figure, a consequence of visibilities will be explained in the text which follows. Let a first network element C1 be allocated to a first user group A. Let a third network element C3 also be allocated to the first user group A. In the drawing, the respective user group A of an associated network element C1, C3 is symbolized noted in brackets underneath the reference symbol for the network element. Let a second network element C2 and a fourth network element C4 be allocated to a second user group B. Let a further network element CX be allocated to a group of administrators as already explained.

In the profile allocated to the first user group A, let communication settings for visibility be set in such a manner that the first user group A cannot see network elements of the second user group B and conversely. The network elements C1, C3 of the first user group A can “see” one another. This is symbolized by continuous lines in the drawing. A nonvisibility of network elements C1, C3 of the first user group A with network elements C2, C4 of the second user group B is symbolized by dashed lines.

Apart from the settings for visibility, further communication settings for a profile of the respective user group A, B comprise settings with respect to a requirement for encryption.

Providing user group allows a simple possibility of blocking an access for entire groups.

1. A method for controlling communication in a decentralized network in which reciprocal decentralized communication is provided for a multiplicity of network elements, comprising:
allocating at least one identity code which is unique in the decentralized network to a user of a first network element;
allocating at least one user group to the identity code; and
allocating a profile for defining communication settings to a user group.

2. The method as claimed in claim 1, wherein the decentralized network is arranged as a peer-to-peer network.

3. The method as claimed in claim 1, wherein in the profile, a visibility of the first network element is defined by at least one second network element a further user group.

4. The method as claimed in claim 1, wherein the profile includes at least one of the following communication settings:
a role in a hierarchy of the decentralized network;
authorization levels;
allowed service relations with network elements within the user group;
allowed service relations with network elements of other user groups;
an authentication device; and
an encryption device.

5. A computer program product for controlling communication in a decentralized network, the computer program product having a computer readable medium that stores instructions executable on the first network element:
allocating at least one identity code which is unique in the decentralized network to a user of a first network element;
allocating at least one user group to the identity code; and
allocating a profile for defining communication settings to a user group.

6. A system for controlling communication in a decentralized network in which reciprocal decentralized communication is provided for a multiplicity of network elements, comprising:
at least one identity code which is unique in the decentralized network is allocated to a user of a first network element;
at least one user group can be allocated to the identity code; and
a profile for defining communication settings is allocated to a user group.
